(19) United States
(12) Patent Application Publication
(10) Pub. No.: US 2002/0150337 A1
(43) Pub. Date: Oct. 17, 2002

(54) Optical waveguide grating and method and mask for forming same

(76) Inventor: Makoto Fujimaki, Tsukuba-shi (JP)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/115,621

(22) Filed: Apr. 4, 2002

(30) Foreign Application Priority Data
Apr. 11, 2001 (JP) 2001-113041
Jun. 6, 2001 (JP) 2001-171087
Dec. 12, 2001 (JP) 2001-379173

(51) Int. Cl. G02B 6/34

(52) U.S. Cl. 385/37; 385/10

(57) ABSTRACT

An optical waveguide grating is formed in an optical waveguide core and/or in an optical waveguide cladding where an electric filed of light propagating in the core is spreading by implanting accelerated ions through a mask to the optical waveguide. The mask has enough thickness to prevent the ions irradiated to the masked parts from reaching the portion where the grating is formed. The acceleration energy of the ions is chosen to make the lateral straggling of the implanted ions in the optical waveguide less than three fourths of the period of the grating, or the acceleration energy is chosen to make all or a part of the implanted ions pass through the portion where the grating is formed.

This application is based on Japanese Patent Application Nos. 2001-113041 filed Apr. 11, 2001, 2001-171087 filed Jun. 6, 2001 and 2001-379173 filed Dec. 12, 2001, the contents of which are incorporated hereinto by reference.

### BACKGROUND OF THE INVENTION

1. Field of the Invention

The present invention relates to an optical waveguide grating, which is commonly known as an optical fiber grating or OFG, a method for forming the optical waveguide grating and a mask for forming the optical waveguide grating. More particularly, the present invention relates to the mask design and the ion implantation method for forming the optical waveguide grating by forming periodic refractive index changes in the wave-guiding portion of an optical waveguide with refractive index changes induced by implanting ions accelerated with high acceleration energy. The wave-guiding portion is commonly called a core for optical fibers and is referred to as ‘core’ or ‘optical waveguide core’ hereafter. The optical waveguide includes optical fibers and planar optical waveguides composed with silica-based glass, semiconductor materials, ferroelectric materials and/or magnetic materials.

2. Description of the Related Art

The optical fiber grating is classified into a fiber Bragg grating, which is commonly called FBG, a Bragg reflection gratings, or Bragg grating, and a long period grating, which is commonly called LPG.

The fiber Bragg grating is formed with the refractive index change portions 5 that is formed periodically in the core 3 of an optical waveguide as shown in FIG. 15. In other words, the periodic refractive index change portion composed with the refractive index change portions 5 forms the fiber Bragg grating. The fiber Bragg grating works as a wavelength-selective mirror by reflecting a light that satisfies the Bragg condition of the periodicity of the refractive index change. This reflection is known as Bragg reflection. The reflected light does not propagate forward any more. Therefore, the fiber Bragg grating is also applied to a wavelength-selective filter. In general, the period of the refractive index change portion 5 is about 0.5 μm.

The long period grating has a period in the range of a few hundred μm to a few mm. The long period grating causes a mode coupling between a guided fundamental mode and a forward propagating cladding mode or leaky mode. As a result, the long period grating works as a wavelength-selective filter to remove a specific light from the optical waveguide. In short, the long period grating removes the light from the core 3 to the cladding 4, which satisfies the following condition.

β₀₁−β_{Cl}=2π/Λ (1)

β₀₁ is the propagation constant of the guided fundamental mode in a core 3, β_{Cl} is the propagation constant of the leaky mode in a cladding 4. Λ is the period of a long period grating.

Conventionally, an optical fiber grating is formed by refractive index change induced by irradiation of grating-shape ultraviolet light to the core of an optical waveguide. A typical formation method of an optical fiber grating by ultraviolet light irradiation is shown in FIG. 15. A phase mask 2 creates an interference fringe pattern of ultraviolet laser light 1, and an optical fiber grating is formed by irradiating the interference fringe pattern to the core 3 of an optical fiber 6 and creating multiple refractive index change portions 5 periodically (U.S. Pat. No. 5,104,209).

However, the ultraviolet light irradiation method has a defect in that the method is only applicable for a special photosensitive optical waveguide in which refractive index change occurs with the ultraviolet light irradiation. Furthermore, the ultraviolet light irradiation method requires a photo-sensitization technique, such as hydrogen loading at room temperature under high pressure of about 200 atm for a period of time of 2 weeks, even if the optical waveguide is made of photosensitive materials, in order to increase the photosensitivity of the optical waveguide when high efficiency is required to the optical fiber grating. The formation process therefore becomes complex.

As an alternative to the ultraviolet light irradiation method, optical fiber grating formation methods by use of ion implantation were invented by Fujimaki, the present inventor, and his co-workers or Clapp et al. (Japanese Patent Application Laid-open NO. 2001-051133, U.S. Pat. No. 6,115,518). Fujimaki et al have also reported the ion implantation method in papers (reference material 1 Makoto Fujimaki et al. “Fabrication of long-period optical fiber gratings by use of ion implantation ” Optics Letters Vol.25, No.2, p.88-89, Jan. 15, 2000.), (reference material 2: Makoto Fujimaki et al. “Ion-implantation-induced densification in silica-based glass for fabrication of optical fiber gratings” Journal of Applied Physics Vol.88, No.10, p.5534-5537, Nov. 15, 2000).

Japanese Patent Application Laid-open NO. 2001-051133 offers the fabrication method of the long period grating that implanting ions through a cladding 4 to a core 3 of an optical fiber, where a mask 7 that has the same shape as the grating of the desired long period grating is used as illustrated in FIG. 16. The long period grating is formed with multiple refractive index change portions 20 that are due to the densification induced by the ion implantation. Furthermore, Japanese Patent Application Laid-open NO. 2001-051133 indicates the fabrication of a fiber Bragg grating by the same method.

However, it is quite difficult for the above-mentioned method to produce a high efficient fiber Bragg grating. The difficulty is due to the spread of the implanted ions. When ions are implanted in a material, the ions are scattered by the atoms in the material and radially spread throughout the material. The width of the spread becomes wider as the projected range of the implanted ions increases. The spread of the implanted ions is negligible in the fabrication of the long period grating shown in Japanese Patent Application Laid-open NO. 2001-051133, since the period of the long period grating is one or two orders of magnitude wider than the lateral width of the spread of the implanted ions. On the other hand, for the fabrication of the fiber Bragg grating by the ion implantation to a core of an optical waveguide through a cladding, the ions are largely scattered when the ions pass through the cladding, and the lateral width of the spread of the ions can be almost equal or larger than the period of the fiber Bragg grating, which results in the overlap of two adjacent refractive index change portions, i.e., two adjacent gratings. Therefore, it is required to find out ion implantation conditions, which take the lateral spread of the ions into account.

In the fiber Bragg grating fabrication method of U.S. Pat. No. 6,115,518, a grating for the fiber Bragg grating is formed during the fabrication process of a silica-based planar optical waveguide. A core layer of silica-based glass is deposited on a silica underlying cladding layer, and the grating is formed by ion implantation at the surface of the core layer. After forming the grating, the core layer is coated with a further core layer, and the two core layers are patterned for an optical waveguide. This is then covered with an upper cladding layer to form a desired waveguide structure. In this method, the implanted ions are germanium ions or phosphorus ions, and the fiber Bragg grating is formed with the refractive index change obtained by the chemical reaction of these ions with atoms in the core layer. The longitudinal thickness of the refractive index change portion is around 100 nm, which is equal to the width of the longitudinal distribution of the implanted ions in the core layer.

This method considers only the case that the projected range of the implanted ions is as small as a few hundred nanometers. The method does not take the lateral spread of the implanted ions into account. However, even in the case that the projected range of the implanted ions is small; if the lateral spread of the implanted ions is not taken into account, two adjacent gratings overlap and the efficiency of the fiber Bragg grating becomes worse.

In the method in U.S. Pat. No. 6,115,518, since the projected range of the implanted ions is small, the refractive index change portion is only formed near the surface of the core layer deposited on the underlying cladding layer and the longitudinal thickness of the refractive index change portion is as small as 100 nm. Higher efficiency of a fiber Bragg grating is obtained with thicker refractive index change portion. However, in this method, it is virtually impossible to form a thick refractive index change portion, since the projected range of the ions is small and the grating is formed only near the surface of the core.

Fujimaki, the present inventor, and his co-workers have estimated in the reference material 2 that a fiber Bragg grating would be obtained by employing an optical waveguide with a thin cladding or ions with small lateral straggling, i.e., ions of heavy atoms, because these conditions reduce the lateral spread of implanted ions. However, even in the case that the cladding is thin and/or the implanted ions are heavy, there still exists the lateral spread of the ions and two adjacent gratings overlapping. Thus the efficiency of the fiber Bragg grating becomes worse. Furthermore, an acceleration energy of more than tens of mega electron volts is required to make the heavy ions reach the core through the cladding. If an acceleration energy of more than 50 MeV is required, the ion accelerator will be so expensive that the method is of no practical use.

As mentioned above, there is a problem in the conventional ion implantation methods in that the methods are not applicable for the fabrication of a fiber Bragg grating in an optical waveguide with a thick cladding of tens of microns. Furthermore, the conventional ion implantation methods are not good enough for the fabrication of a high efficiency fiber Bragg grating even in an optical waveguide with a thin cladding or without cladding.

The fiber Bragg grating fabrication method by ion implantation requires a mask to create the periodic refractive index change. The mask is one of the most important components for the method. However, masks suitable for the method have not been designed so far.

### SUMMARY OF THE INVENTION

The present invention offers a mask for forming a desired optical waveguide grating and ion-implantation conditions for forming the optical waveguide grating with the mask, which are made by considering the lateral spread of the implanted ions in an optical waveguide in order to form a periodic refractive index change in a core and/or near the core of an optical waveguide. The optical waveguide includes an optical fiber and a planar optical waveguide formed with silica-based glass, semiconductor materials, ferroelectric materials, and/or magnetic materials. More concretely, the present invention reduces the effect of the ion spread, creates a high contrast in the formed periodic refractive index change, and realizes the fabrication of a desired high efficient optical waveguide grating by using a mask that has enough thickness to prevent the ions irradiated to the masked parts from reaching the portion where the optical waveguide grating is formed and by implanting ions to an optical waveguide with conditions in which the lateral straggling of the implanted ions is less than three fourths of the period of the optical waveguide grating or conditions in which the implanted ions pass through the portion where the optical waveguide grating is formed.

In detail, an optical waveguide grating of the present invention is formed in an optical waveguide core and/or in an optical waveguide cladding where an electric field of light propagating in the core is spreading, and comprises a periodic refractive index change portion formed in the core and/or in the cladding by implanting accelerated ions into the core and/or into the cladding through a mask, wherein the thickness of the mask is thick enough to prevent the ions irradiated to the masked parts from reaching the core, or the height of projections against grooves that correspond to slits of the mask is high enough to prevent the ions irradiated to the projections from reaching the core.

Furthermore, an optical waveguide grating of the present invention is formed in an optical waveguide core and/or in an optical waveguide cladding where an electric field of light propagating in the core is spreading, and comprises a periodic refractive index change portion formed in the core and/or in the cladding by implanting accelerated ions into the core and/or into the cladding through a mask, wherein the thickness of the mask is thick enough to prevent the ions irradiated to the masked parts from reaching a portion where the optical waveguide grating is formed, or the height of projections against grooves that correspond to slits of the mask is high enough to prevent the ions irradiated to the projections from reaching a portion where the optical waveguide grating is formed.

Preferably, the thickness of the mask is thinner than the projected range of the implanted ions, or the height of the projections against the grooves that correspond to the slits of the mask is lower than the projected range of the implanted ions.

A method of the present invention for forming an optical waveguide grating comprises the steps of implanting accelerated ions into an optical waveguide core and/or into an optical waveguide cladding where an electric field of light propagating in the core is spreading through a mask and forming a periodic refractive index change portion in the core and/or in the cladding by the ion implantation, wherein the thickness of the mask is thick enough to prevent the ions irradiated to the masked parts from reaching the core, or the height of projections against grooves that correspond to slits of the mask is high enough to prevent the ions irradiated to the projections from reaching the core.

A method of the present invention for forming an optical waveguide grating comprises the steps of implanting accelerated ions into an optical waveguide core and/or into an optical waveguide cladding where an electric field of light propagating in the core is spreading through a mask and forming a periodic refractive index change portion in the core and/or in the cladding by the ion implantation, wherein the thickness of the mask is thick enough to prevent the ions irradiated to the masked parts from reaching a portion where the optical waveguide grating is formed, or the height of projections against grooves that correspond to slits of the mask is high enough to prevent the ions irradiated to the projections from reaching a portion where the optical waveguide grating is formed.

A mask of the present invention for forming an optical waveguide grating has a grating shape composed with a plurality of slits with a width of 50 nm to 5 μm and slit-forming portions with a width of 50 nm to 5 μm.

The mask of the present invention for forming an optical waveguide grating, which is mentioned in any one of the above descriptions, has, on a flat plate, a plurality of grooves corresponding to the slits and projections corresponding to the slit-forming portions, the grooves and the projections being periodically formed.

The mask of the present invention for forming an optical waveguide grating, which is mentioned in any one of the above descriptions, has a plurality of holes which are periodically formed in a manner corresponding to the slits on a flat plate.

Preferably, the above-mentioned mask is formed by coating or deposition of metals, semiconductor materials, ceramic materials, or polymer materials with a grating shape that corresponds to the slits and the slit-forming portions on the cladding surface of the optical waveguide.

Preferably, the above-mentioned mask is formed by coating or deposition of metals, semiconductor materials, ceramic materials, or polymer materials with a grating shape that corresponds to the slits and the slit-forming portions on the surface of the core layer of the optical waveguide before forming an upper cladding.

Preferably, the above-mentioned mask is formed by giving periodic grooves corresponding to the slits and projections corresponding to the slit-forming portions to the cladding of the optical waveguide by etching or scraping.

Preferably, the slits of the mask are filled with materials that have smaller ion stopping power than the material of the mask.

Preferably, the sum of the widths of the slit and the slit-forming portion satisfies the Bragg reflection condition of the light to be filtered in the optical waveguide.

Another optical waveguide grating of the present invention is formed in an optical waveguide core and/or in an optical waveguide cladding where an electric field of light propagating in the core is spreading, and comprises a periodic refractive index change portion formed in the core and/or in the cladding by implanting accelerated ions into the core and/or into the cladding through a mask, wherein the acceleration energy is chosen to make the lateral straggling of the implanted ions in the optical waveguide less than three fourths of the period of the refractive index change portion.

Another optical waveguide grating of the present invention is formed in an optical waveguide core and/or in an optical waveguide cladding where an electric field of light propagating in the core is spreading, and comprises a periodic refractive index change portion formed in the core and/or in the cladding by implanting accelerated ions into the core and/or into the cladding through a mask, wherein the acceleration energy is chosen to make all or a part of the implanted ions pass through the portion where the periodic refractive index change is formed.

Preferably, the periodic refractive index change is formed in the core and/or in the cladding by implanting the ions with varying acceleration energy.

Preferably, apodisation is given to the value of the periodic refractive index change by irradiating the beam of the ions that is scanned along the core of the optical waveguide and varying the scanning speed of the beam of the ions.

Preferably, the beam of the ions is irradiated to and diffracted by a film, and apodisation is given to the value of the periodic refractive index change by making a distribution of the implanted ions from the center to the edges of the optical waveguide grating by irradiating the diffracted ion beam to the optical waveguide through the mask.

Another optical waveguide grating of the present invention is formed in an optical waveguide core and/or in an optical waveguide cladding where an electric field of light propagating in the core is spreading, and comprises a periodic refractive index change portion with apodisation along the core of the optical waveguide formed by ion implantation or ultraviolet light irradiation, wherein the average refractive index of the apodised optical waveguide grating is flattened by irradiating an ion beam that is scanned along the core of the optical waveguide and varying the scanning speed of the ion beam.

Another optical waveguide grating of the present invention is formed in an optical waveguide core and/or in an optical waveguide cladding where an electric field of light propagating in the core is spreading, and comprises a periodic refractive index change portion with apodisation along the core of the optical waveguide formed by ion implantation or ultraviolet light irradiation, wherein an ion beam, which has a distribution profile that is the inverse of the average refractive index profile of the apodised optical waveguide grating, is formed by ion beams that have been irradiated to and diffracted by a film, and the average refractive index of the apodised optical waveguide grating is flattened by irradiating the ion beam.

Another method of the present invention for forming an optical waveguide grating comprises the steps of implanting accelerated ions into an optical waveguide core and/or into an optical waveguide cladding where an electric field of light propagating in the core is spreading through a mask and forming a periodic refractive index change portion in the core and/or in the cladding by the ion implantation, wherein the acceleration energy is chosen to make the lateral straggling of the implanted ions in the optical waveguide less than three fourths of the period of the refractive index change portion.

Another method of the present invention for forming an optical waveguide grating comprises the steps of implanting accelerated ions into an optical waveguide core and/or into an optical waveguide cladding where an electric field of light propagating in the core is spreading through a mask and forming a periodic refractive index change portion in the core and/or in the cladding by the ion implantation, wherein the acceleration energy is chosen to make all or a part of the implanted ions pass through the portion where the periodic refractive index change is formed.

Preferably, the methods mentioned above use the ion implantation method in which the periodic refractive index change is formed in the core and/or in the cladding by implanting the ions with varying acceleration energy.

Preferably, the methods mentioned above use the ion implantation method in which apodisation is given to the value of the periodic refractive index change by irradiating the beam of the ions that is scanned along the core of the optical waveguide and varying the scanning speed of the beam of the ions.

Preferably, the methods mentioned above use the ion implantation method in which the beam of the ions is irradiated to and diffracted by a film, and apodisation is given to the value of the periodic refractive index change by making a distribution of the implanted ions from the center to the edges of the optical waveguide grating by irradiating the diffracted ion beam to the optical waveguide through the mask.

Preferably, the methods mentioned above form an optical waveguide grating greater than the diameter of the beam of the ions by irradiating the beam of the ions that is scanned along the core of the optical waveguide.

Another method of the present invention for forming an optical waveguide grating in an optical waveguide core and/or in an optical waveguide cladding where an electric field of light propagating in the core is spreading, comprises the steps of forming a periodic refractive index change portion with apodisation along the core of the optical waveguide by ion implantation or ultraviolet light irradiation and flattening the average refractive index of the apodised optical waveguide grating by irradiating an ion beam that is scanned along the core of the optical waveguide and varying the scanning speed of the ion beam.

Another method of the present invention for forming an optical waveguide grating in an optical waveguide core and/or in an optical waveguide cladding where an electric field of light propagating in the core is spreading, comprises the steps of forming a periodic refractive index change portion with apodisation along the core of the optical waveguide by ion implantation or ultraviolet light irradiation, forming an ion beam, which has a distribution profile that is the inverse of the average refractive index profile of the apodised optical waveguide grating, by ion beams that have been irradiated to and diffracted by a film, and flattening the average refractive index of the apodised optical waveguide grating by irradiating the ion beam.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1A is a perspective view illustrating an example of a mask with holes that correspond to the slits used in the embodiment of the present invention,

FIG. 1B is a cross-sectional view cut along the line IB-IB in FIG. 1A;

FIG. 2 is a perspective view illustrating an example of a mask used in the embodiment of the present invention where grooves that correspond to slits are formed on a constant thickness plate;

FIG. 3 is a conceptual cross-sectional view illustrating the ion implantation method of the present invention that stops ions irradiated to the masked parts within an optical waveguide cladding;

FIGS. 4A-4B are cross-sectional views illustrating an example of a mask composed with grooves on the surface of an optical waveguide cladding in the embodiment of the present invention;

FIGS. 5A-5B depict the embodiment of the present invention,

FIG. 5A is a drawing in which black dots indicate densified portions in silica glass by hydrogen-ion implantation through a mask,

FIG. 5B is a graph illustrating refractive index increase induced around the portion where the hydrogen ions stop;

FIGS. 6A-6D are schematic descriptive views illustrating the fiber Bragg grating fabrication process in the embodiment of the present invention where an upper cladding is formed after forming a grating in a core layer;

FIGS. 7A-7B are graphs illustrating the correlation between the projected ranges and the lateral straggling of various ion species in silica glass;

FIGS. 8A-8E are schematic descriptive views illustrating the fiber Bragg grating fabrication process in the embodiment of the present invention where a grating is formed by implanting ions in a core of an optical waveguide with a thin upper cladding and additional cladding is applied until the desired thickness is reached after forming the grating;

FIG. 9A is a drawing in which black dots indicate portions where refractive index change is induced by ion implantation,

FIG. 9B is a graph illustrating the refractive index change of a grating formed with the portion surrounded by the square in FIG. 9A;

FIGS. 10A-10C are cross-sectional views illustrating cores of optical waveguides in the embodiment of the present invention in which hydrogen ions or helium ions form refractive index changes when these ions pass through the cores;

FIG. 11A is a graph illustrating refractive index change of a fiber Bragg grating without apodisation,

FIG. 11B is a graph illustrating refractive index change of an apodised fiber Bragg grating,

FIG. 11C is a graph illustrating refractive index change of an apodised fiber Bragg grating with a flat average refractive index;

FIG. 12 is a graph illustrating distribution of hydrogen ions that are irradiated to an aluminum film of 30 μm thickness with an acceleration energy of 3.5 MeV and diffracted by the film in the embodiment of the present invention;

FIGS. 13A-13C are schematic descriptive views illustrating the embodiment of the method of the present invention for forming an apodised fiber Bragg grating where an accelerated ion beam is irradiated to and diffracted by a film and the diffracted ion beam is irradiated to an optical waveguide through a mask;

FIGS. 14A-14E are schematic descriptive views illustrating the embodiment of the method of the present invention for forming an apodised fiber Bragg grating with a flat average refractive index by irradiating the edges of two diffracted ion beams to a fiber Bragg grating with apodisation profile as illustrated in FIG. 11B;

FIG. 15 is a schematic cross-sectional view illustrating the conventional fabrication method of optical fiber gratings with ultraviolet light irradiation; and

FIG. 16 is a schematic cross-sectional view illustrating the fabrication method of optical fiber gratings with ion implantation in Japanese Patent Application Laid-open NO. 2001-051133 by the present inventor and his co-workers.

### DETAILED DESCRIPTION OF PREFERRED EMBODIMENTS

The configurations of an optical waveguide grating, a method for forming the optical waveguide grating and a mask for forming the optical waveguide grating according to the embodiments of the present invention will be described below with reference to the drawings.

[Special Features of Masks]

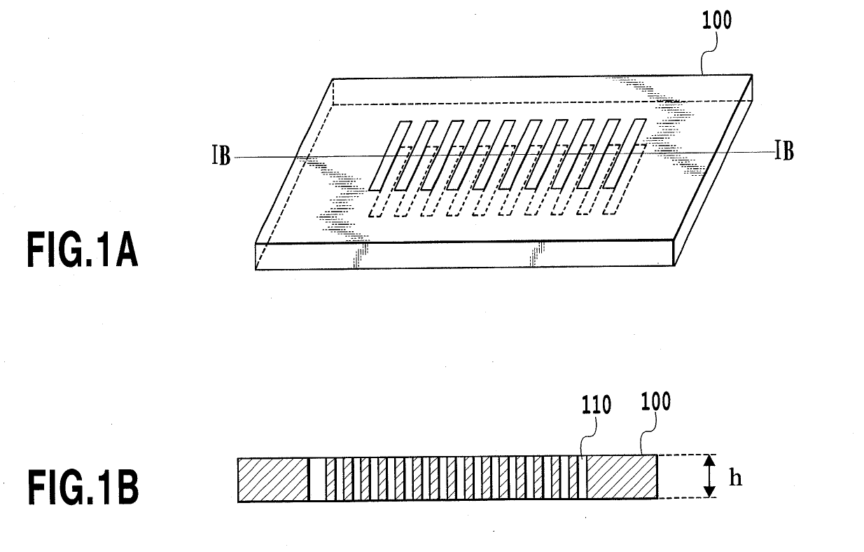

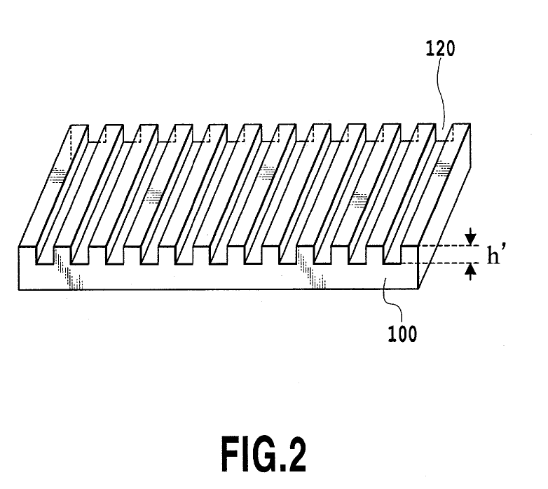

A mask used in the embodiment of the present invention is a mask 100 with a grating shape as shown in FIGS. 1A-1B or FIG. 2. Here, the external form of the mask may not be square and can be any shape. The number of the grating depends on the reflection/transmission ratio and width of the reflection/transmission spectrum of the desired fiber Bragg grating. If the number of the grating is small, the reflection/transmission ratio will be small and the width of reflection/transmission spectrum will be wide; conversely, if the number of the grating is large, the reflection/transmission ratio will be large and the width of reflection/transmission spectrum will be narrow.

[Grating Shapes of the Mask]

The shape of the mask in the embodiment of the present invention is described in detail below. The width of the slit is designed to be in a range of 50 nm to 5 μm. The width of the slit should be as small as possible, since a wide slit makes the period of a fiber Bragg grating larger, which results in the deterioration of the efficiency of the fiber Bragg grating. The mask pattern is formed by microscopic processing technologies, such as electron beam lithography, photolithography, or X-ray lithography. These technologies, for example the electron beam lithography, can draw a pattern with a 20-nm width. However, such small patterns are not practical and the mask will be quite expensive. For these reasons, the present inventor has found that the best slit width is in the range of 50 nm to 5 μm.

Slit-forming portions, i.e., the spaces between the slits, are also designed to be in a range of 50 nm to 5 μm for the same reason. The period of the mask pattern of the present invention, i.e., the period A of the fiber Bragg grating fabricated with the mask, is a summation of the widths of the slit and the slit-forming portion. Therefore, the summation of the widths of the slit and the slit-forming portion should be designed to satisfy the desired Bragg reflection condition.

Generally, the period A of the fiber Bragg grating is determined by the Bragg reflection condition as:

Λ=λ×N/2n (2)

where λ is a wavelength of a light to be reflected, N an integer greater than or equal to 1, i.e., N≧1, n an effective refractive index of the light with the wavelength of λ propagating in the core of the optical waveguide having the fiber Bragg grating. The period Λ of the fiber Bragg grating with N=1 is calculated to be 0.53 μm to obtain a reflection of a light with a wavelength of 1.55 μm in a typical silica-based optical waveguide with effective refractive index n of 1.46. The reflection of the 1.55 μm light can be obtained if N is greater or equal to 2, i.e., if the period of the fiber Bragg grating is 0.53×N μm (N≧2). However, reflection efficiency decreases with increases in N. Therefore, the number of the grating of the fiber Bragg grating with N≧2 must be increased to obtain the efficiency of a fiber Bragg grating with N=1. Since the product of the period and the number of the grating determines the length of the fiber Bragg grating, the length of the fiber Bragg grating becomes longer with increases in N.

The mask 100 is one with holes corresponding to slits 110 as shown in FIGS. 1A-1B or one with grooves corresponding to slits 120 and projections corresponding to slit-forming portions formed on a plate with a constant thickness as shown in FIG. 2. Since the mask 100 consists of the micron-size slits and the micron-size slit-forming portions, the mask 100 is easily deformed. Therefore, the mask 100 can be reinforced by filling the slits with materials that have smaller ion stopping power than the material of the mask, i.e., materials which ions easily pass through. Previously, the thickness of the mask had been required to be thick enough to prevent the ions irradiated to the masked parts from reaching the optical waveguide, while the present inventor has found that it is enough for the thickness h or h′ to prevent the ions irradiated to the masked parts from reaching the portion where the fiber Bragg grating is formed, e.g., the core.

If the thickness h or h′ is thicker than the projected range of the implanted ions, the ions irradiated to the masked parts stop in the mask 100 and the mask 100 prevents the ions irradiated to the masked parts from reaching the optical waveguide. However, masks with thick h or h′ are quite expensive.

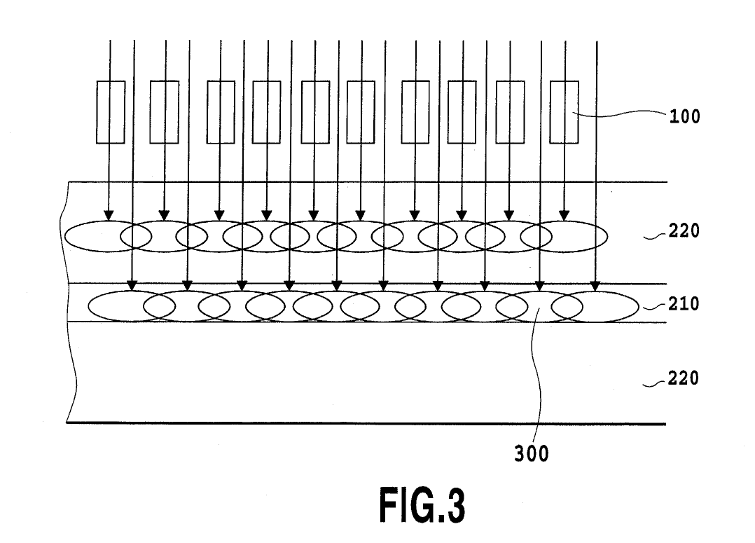

When a grating is formed in a core 210 by using the mask with thickness of h or h′ to prevent the ions irradiated to the masked parts from reaching the core 210, the ions irradiated to the non-masked parts reach the core 210, while the ions irradiated to the masked parts stop in the cladding 220 as shown in FIG. 3, thus the fiber Bragg grating with the refractive index change portions 300 is formed in the core 210. For example, when hydrogen ions are implanted in the center of the core of a silica-based optical fiber with a cladding of 60 μm thickness and a core of 9 μm diameter, the required thickness of the mask made of silica glass is 7 μm. If the mask is made of gold, the required thickness is 2 μm. If the cladding and/or the core are thinner, the thickness of the mask can be thinner. In other words, the ion implantation method of the present invention uses the cladding 220 as a part of the mask.

The above-mentioned mask 100 is made of metals, semiconductor materials, ceramic materials, and/or polymer materials with well developed microscopic processing technologies.

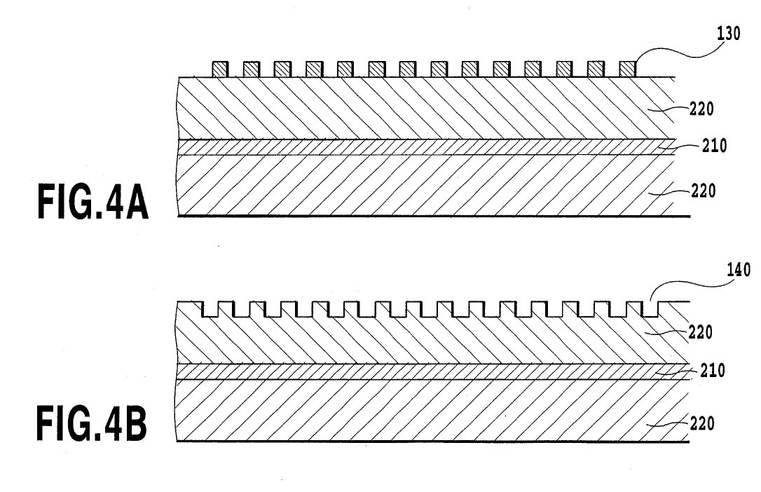

FIGS. 4A-4B illustrate the modified embodiment of the ion implantation method using the cladding as a part of the mask. As shown in FIGS. 4A-4B, a mask 100 can be formed by making grooves on a cladding 220, whose height is enough to prevent implanted ions from reaching the portion where an optical fiber grating is formed. The mask is formed with metals 130 (or semiconductor materials, ceramic materials, or polymer materials) deposited or coated on the cladding 220 with a grating shape. The mask is also formed by grooves 140 created by etching or scraping the cladding with a grating shape.

[Ion-Implantation Conditions]

Ion implantation into silica-based glass causes a densification of the glass, which results in a refractive index increase. The highest refractive index increase occurs around the portion where the implanted ions stop. Hence, in a silica-based optical waveguide, it is most effective to fabricate a fiber Bragg grating with the refractive index increase around the portion where the ions stop. However, this portion is strongly influenced by the spread of the ions. To minimize the influence of the lateral spread of the ions, to prevent overlap of two adjacent gratings, and to fabricate an effective fiber Bragg grating, the present inventor has found the ion implantation method that chooses an acceleration energy under which the lateral straggling of implanted ions in an optical waveguide is less than three fourths of the period of a fiber Bragg grating. The lateral straggling is an index of the lateral spread of ions.

The embodiment of the method of the present invention will be described below.

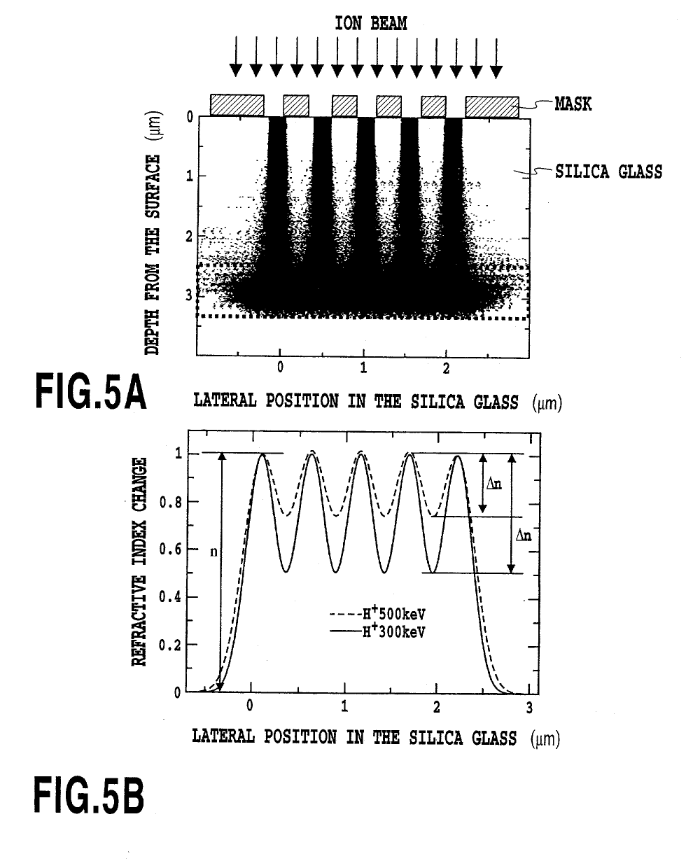

First, the fabrication of a fiber Bragg grating with N=1 in a silica-based optical waveguide, i.e., a fiber Bragg grating with the period of 0.53 μm, is described. The black dots in FIG. 5A indicate the densified portion in silica glass by implantation of hydrogen ions accelerated with 300 keV through a mask with slits of 0.2 μm width and slit-forming portions of 0.33 μm width. The refractive index increase is large at the portion where the black dots are dense, while the refractive index increase is small at the portion where the black dots are thin. The solid curve in FIG. 5B indicates the periodic refractive index change formed around the portion where the implanted hydrogen ions stopped. The portion where the implanted ions stopped means the portion surrounded by the broken-line square in FIG. 5A. The lateral straggling of hydrogen ions implanted in a silica glass with acceleration energy of 300 keV is 0.26 μm, which is about half of the fiber Bragg grating's period of 0.53 μm. An overlap of the adjacent refractive index increase portions, i.e., two adjacent gratings, is seen in FIG. 5A; but a fine periodic refractive index change is formed as seen in FIG. 5B, indicating that a fiber Bragg grating is formed.

Here, the mask with a slit of 0.2 μm width is employed. Much fine periodic refractive index changes are obtained by using a mask with much narrower slits.

The broken curve in FIG. 5B indicates the periodic refractive index change formed by the implantation of hydrogen ions with an acceleration energy of 500 keV through a mask with slits of 0.1 μm width and slit-forming portions of 0.43 μm width. The lateral straggling of the hydrogen ions in a silica glass is 0.38 μm, which is about three fourths of the fiber Bragg grating's period of 0.53 μm. As shown in FIG. 5B, the height of the periodic refractive index change indicated by Δn is about 20% of the maximum refractive index increase indicated by n. The maximum refractive index increase obtained in silica glass, i.e., the maximum of n, by ion implantation is about 0.01, which means that Δn of 0.002 can be achieved. It is known that Δn of 0.001 is enough to fabricate a fiber Bragg grating. Therefore, this ion-implantation condition is also good enough to fabricate an effective fiber Bragg grating.

Now, description of the fabrication process of the fiber Bragg grating with 0.53 μm period in a silica-based planar optical waveguide by implanting hydrogen ions accelerated with 300 keV will be given. As shown in FIG. 5A, the projected range of the hydrogen ions is around 3 μm. Hence, it is impossible to form a fiber Bragg grating in the core or in the cladding around the core where the electric field of the light propagating in the core is spreading, if the thickness of the cladding is more than 10 μm. Therefore, a fabrication process forming an upper cladding following the formation of a grating in a core without the upper cladding is described.

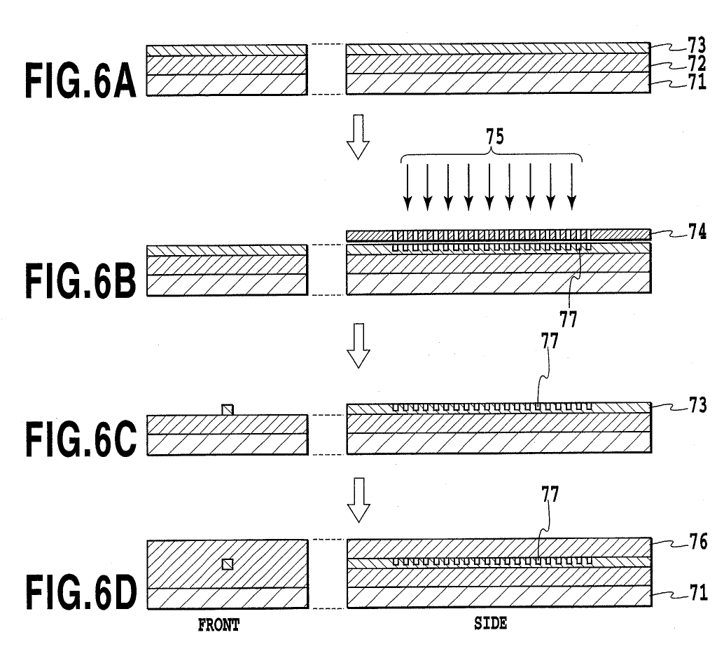

The fabrication process is illustrated in FIGS. 6A-6D and composed as follows.

A: An underlying cladding layer 72 of silica-based glass with thickness of 20 μm is formed on a Si or a SiO₂ substrate 71. A core layer 73 of silica-based glass with thickness of 6 μm is deposited on the underlying cladding layer 72. (Process shown in FIG. 6A)

B: Hydrogen ions 75 are implanted in the core layer through a mask 74, which satisfies the above-mentioned mask conditions. (Process shown in FIG. 6B)

C: The core layer 73 is modified by a process such as reactive ion etching and the desired optical waveguide structure is formed. (Process shown in FIG. 6C)

D: An upper cladding 76 of silica-based glass is formed. (Process shown in FIG. 6D)

In this example, the widths of the slit and the slit-forming portion of the mask are 0.2 and 0.33 μm, respectively. The mask 74 is made of gold with a thickness of 1.5 μm. The ions irradiated to the slit-forming portions stop in the mask 74.

The ion implantation forms a grating with a plurality of refractive index change portions 77 at the depth of 3 μm from the surface of the core layer 73 in FIG. 6B, i.e., the center of the core. The refractive index change formed by the ion implantation is indicated by the solid curve in FIG. 5B. The core layer 73 that has the periodic refractive index change portion composed with the refractive index change portions 77 is modified by the reactive ion etching and the desired optical waveguide structure is formed as shown in FIG. 6C. In addition to that, an upper cladding is deposited on it as shown in FIG. 6D, and an optical waveguide grating is formed.

The cladding layer and the core layer are commonly formed by the chemical vapor deposition method or the flame hydrolysis deposition method. The deposition process of the upper cladding is commonly performed under temperatures higher than 400° C. Therefore, the substrate 71 will be more than 400° C. during the deposition of the upper cladding. The fiber Bragg grating keeps its property during the deposition of the upper cladding, since the refractive index change induced in silica glass by ion implantation decreases only 10% when the glass is heated at 500° C. for 2 hours. Even if the glass is heated at 800° C. for 2 hours, 50% of the refractive index change remains.

In the above-mentioned fabrication process, the same fiber Bragg grating is obtained if process B is done after process C.

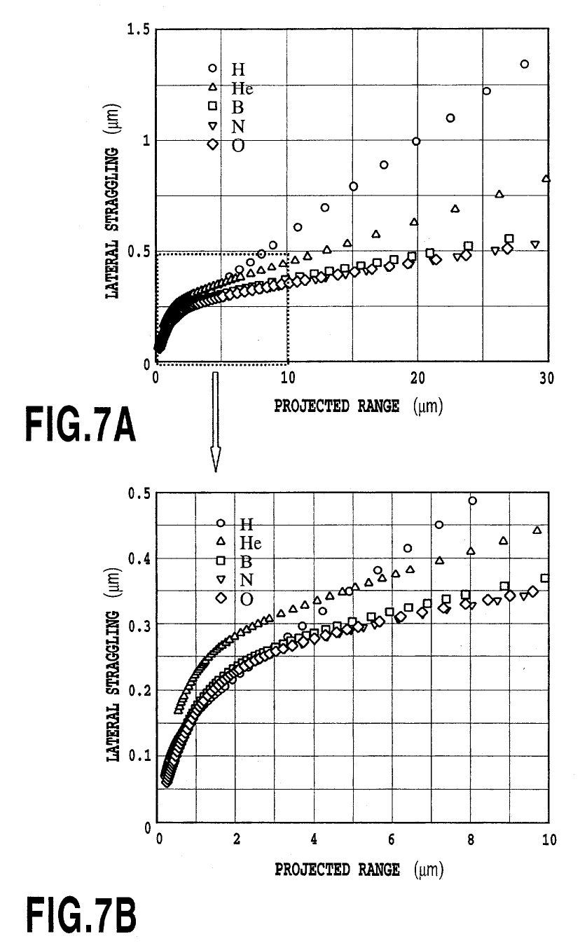

In the above-mentioned fabrication process, hydrogen ions are employed, though other ions are also applicable. FIGS. 7A-7B indicate the correlation between the projected ranges and the lateral straggling of hydrogen (H), helium (He), boron (B), nitrogen (N), and oxygen (O) ions in silica glass. By using ions that have small lateral straggling, e.g., nitrogen ions or oxygen ions, for the fabrication of the fiber Bragg grating with the period of 0.53 μm, the grating can be formed at much a deeper position from the surface. Therefore, the fiber Bragg grating with N=1 is formed in the core or in the cladding where the electric field of the light propagating in the core is spreading, even if the optical waveguide has a cladding of about 10 μm thickness.

The lateral straggling of ions of atoms heavier than oxygen is similar to that of oxygen ions. Hence, the further improvement of the overlap of the adjacent two gratings is not expected by ions of atoms heavier than oxygen. However, ions of heavy atoms induce large refractive index change with a small dose. Therefore, large refractive index change is induced with short time, and, as a result, fabrication time can be shortened.

If the cladding is much thicker, a fiber Bragg grating with a grating period corresponding to N>1 may be chosen.

All ions that can be accelerated by existing accelerators are applicable for the fabrication of the fiber Bragg grating. However, ions of heavy atoms require high acceleration energy to obtain long projected ranges. Therefore, ions of atoms whose atomic numbers are less than or equal to 36 are good in the case that a projected range of more than 10 μm is required. These ions have projected ranges of more than 10 μm under an acceleration energy of less than 50 MeV. Ions that cause refractive index changes by chemical reactions with silica glass can increase the effect of the refractive index change. For example, germanium, phosphorus, tin, and titanium ions cause refractive index increases by chemical reactions with silica glass, while boron and fluorine ions cause refractive index decreases.

The concentration of the implanted ions must be more than 0.01% in the glass, when the refractive index change for the fiber Bragg grating is formed with the chemical reactions.

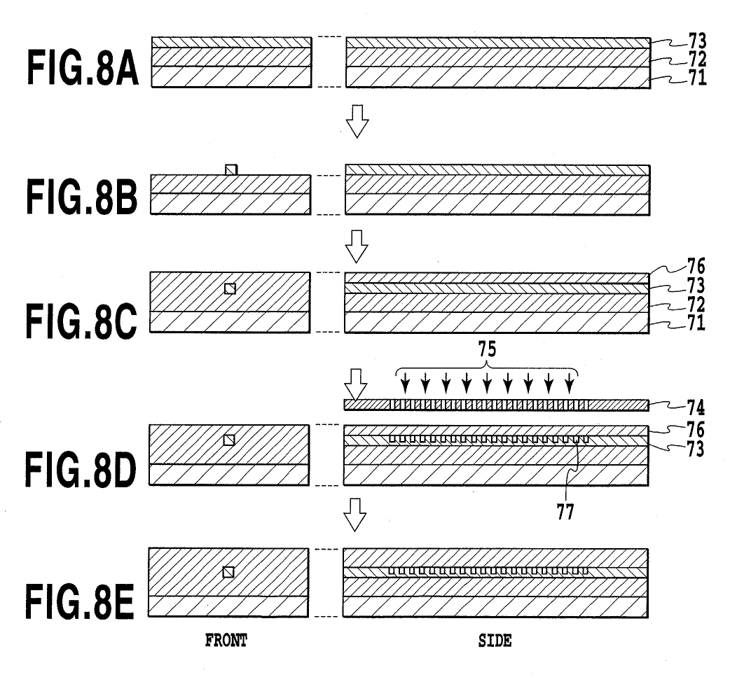

As for the formation of an optical waveguide having a fiber Bragg grating with a thick cladding, the modified embodiment of the method of the present invention forms a fiber Bragg grating by implanting ions to an optical waveguide with a thin cladding and deposits a cladding again on the optical waveguide to a desired thickness. An example of this fabrication process is shown in FIGS. 8A-8E.

As illustrated in FIG. 8A, an underlying cladding layer 72 and a core layer 73 are deposited on a substrate 71. The core layer 73 is modified by reactive ion etching and a desired optical waveguide structure is formed as shown in FIG. 8B. Then, an upper cladding 76 with a thickness of less than 10 μm is deposited on it as shown in FIG. 8C. Next, ions 75 are implanted into the waveguide through a mask 74 as shown in FIG. 8D, and the upper cladding 76 is deposited again to thicken the cladding as shown in FIG. 8E. Through these processes, an optical waveguide, which has the fiber Bragg grating formed with refractive index change portions 77, with the thick cladding is obtained.

The electric field of the light propagating in a single-mode optical waveguide spreads not only in the core but also in the cladding near the core. Therefore, if a fiber Bragg grating is formed only in the core, diffraction occurs on the boundary surface between the core and the cladding. Since the diffracted lights that satisfy the coupling condition with leaky modes have wavelengths shorter than the Bragg reflection wavelength, undesirable radiation losses at the shorter wavelength region appear. The losses are peculiar to fiber Bragg gratings. It has been known that the formation of a refractive index change in the cladding, which has the same profile as that of the fiber Bragg grating, suppresses the radiation losses.

In the modified embodiment illustrated in FIGS. 8A-8E, ions are implanted in the core 73 surrounded by the cladding 76 as shown in FIG. 8D. Therefore, the ion implantation forms a periodic refractive index change in the cladding 76 around the core 73, which has the same profile that in the core. Thus, a fiber Bragg grating with small radiation losses is fabricated.

The fiber Bragg grating fabricated with the mask and the ion-implantation conditions in the embodiment of the present invention shows a smaller overlap of two adjacent gratings than that which was fabricated by the conventional ion-implantation methods. Thus, effective fiber Bragg gratings are obtained. The longitudinal thickness of the refractive index change portion of a fiber Bragg grating fabricated by the conventional method disclosed in U.S. Pat. No. 6,115,518 is only a few hundred nanometers, while that which was by the method of the present invention is more than 1 μm as shown in FIG. 5A. Thus, more efficient fiber Bragg gratings are obtained. Furthermore, the conventional method disclosed by U.S. Pat. No. 6,115,518 requires a two-step deposition of the core layer, while the method of the present invention requires only one deposited core layer. Thus a simpler fabrication process is realized.

In addition to the above-mentioned method, the present invention chooses an acceleration energy that makes the implanted ions pass through the portion where a fiber Bragg grating is formed. The present inventor found this method also results in suppression of the overlap of two adjacent gratings.

The embodiment of the method will be described by illustrating the case in which a grating shape refractive index change is formed in silica glass at a depth of 9 μm from the surface by hydrogen-ion implantation.

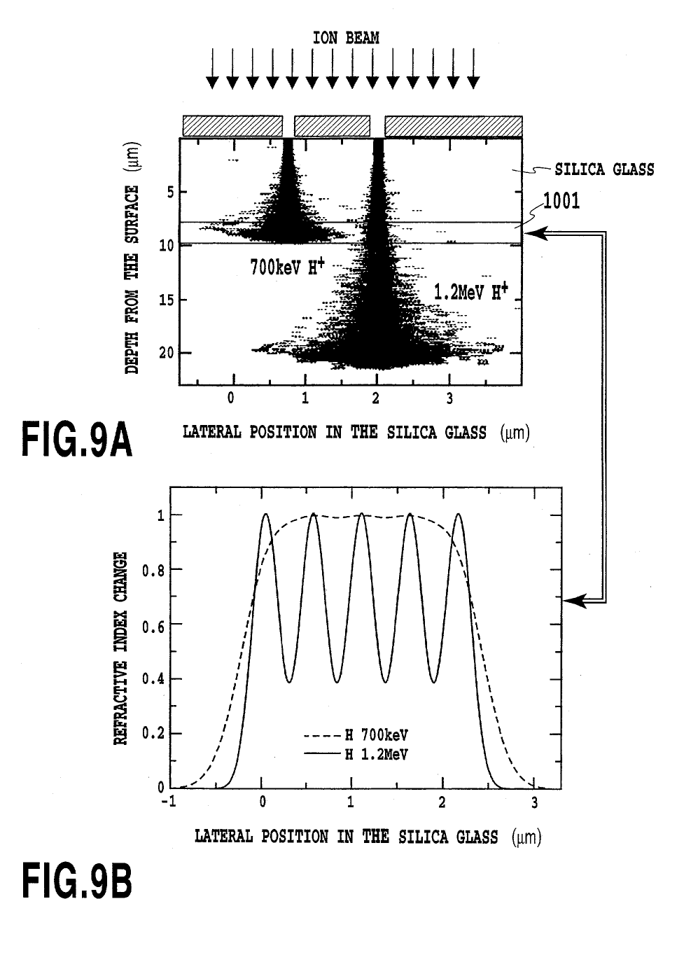

FIGS. 9A-9B illustrate the refractive index change induced at a depth of 9±1 μm from the surface of silica glass by hydrogen ions accelerated with 700 keV or 1.2 MeV, where the hydrogen ions accelerated with 700 keV stop around the portion at the depth of 9 μm from the surface, while the other hydrogen ions, those accelerated with 1.2 MeV, pass through this portion. FIG. 9A illustrates the portion where the refractive index change is induced. The width of the refractive index change portion induced by the hydrogen ions accelerated with 700 keV is more than 1 μm at the depth of 9 μm from the surface, while that induced by the hydrogen ions accelerated with 1.2 MeV is about 0.3 μm. The lateral straggling of the hydrogen ions accelerated with 700 keV in silica glass is 0.53 μm. The hydrogen ions accelerated with 1.2 MeV stop at a depth of about 20 μm from the surface.

FIG. 9B indicates the refractive index changes of the gratings formed by the refractive index change portions surrounded by square 1001 in FIG. 9A. In this case, a mask with a slit of 0.1 μm width and a slit-forming portion of 0.43 μm width is employed.

The implantation of the hydrogen ions accelerated with 700 keV does not form a grating shape refractive index change at the depth of 9 μm because of the overlap of two adjacent gratings. On the other hand, the implantation of the hydrogen ions accelerated with 1.2 MeV forms a clear grating shape refractive index change.

Thus, the present inventor found that a desired fiber Bragg grating is formed by suppressing the overlap of two adjacent gratings by choosing an acceleration energy with which the implanted ions do not stop within, but pass through the portion, where the fiber Bragg grating is formed.

As the embodiment of the invented method, the fabrication of a 0.53 μm period fiber Bragg grating in a silica-based planar optical waveguide using the hydrogen ions accelerated with 1.2 MeV will be described below. As mentioned above, the hydrogen ions form a clear grating shape refractive index change at the depth of 9 μm from the surface. First, the fabrication process illustrated in FIGS. 6A-6D, in which the upper cladding 76 is formed following the formation of the refractive index change portions 77, is described.

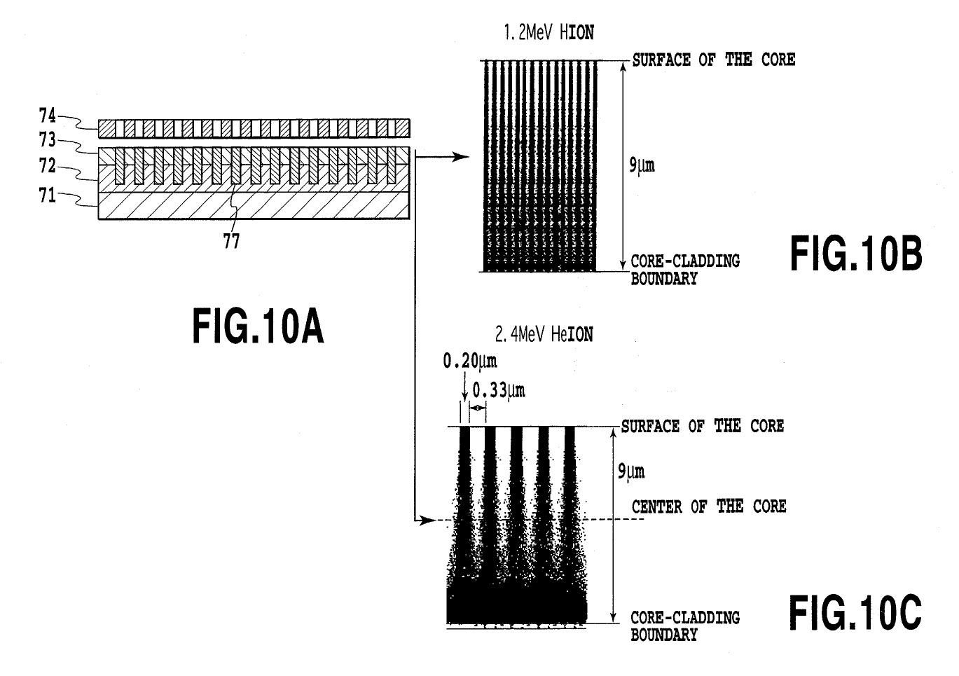

The thickness of the underlying cladding 72 and the core layer 73 are 20 and 9 μm, respectively. The widths of the slit and the slit-forming portion of the mask 74 are 0.2 and 0.33 μm, respectively. The mask 74 is made of gold with a thickness of 8 μm. The ions irradiated to the slit-forming portions stop in the mask. FIG. 10B illustrates the refractive index change at the cross section of the core layer formed by the ion implantation. A grating shape is formed throughout the cross section of the core 73 as shown in FIG. 10B. The fiber Bragg grating is obtained by depositing the upper cladding 76 following the process in which the core layer with the refractive index change portions 77 is modified by reactive ion etching and the desired optical waveguide shape is formed.

In the above-mentioned embodiment of the present invention, the refractive index change is formed in the portion where the implanted ions pass through. Hence, the refractive index change portion 77 is formed along the ion track. Therefore, the grating shape refractive index change is formed throughout the cross section of the core, i.e., from the top to the bottom of the core, as shown in FIG. 10B. Therefore, a fiber Bragg grating with high efficiency is obtained.

If the hydrogen ions accelerated with 700 keV are employed in the above-mentioned method, grating shape refractive index change is not formed at a depth of 9 μm from the surface as shown in FIGS. 9A-9B. This means that no grating shapes are formed at the lower part of the core by the ions in the above-mentioned fabrication process. However, the ions form a grating at the center of the core when the ions pass through the center. Therefore, the ions form the fiber Bragg grating in the center of the core, even though the efficiency of the fiber Bragg grating is not better than that formed by the hydrogen ions accelerated with 1.2 MeV. The thickness of the mask for the hydrogen ions accelerated with 700 keV can be less than half of that of the hydrogen ions accelerated with 1.2 MeV. Therefore, the price of the mask for the implantation of the hydrogen ions accelerated with 700 keV will be cheaper than that of the implantation of the hydrogen ions accelerated with 1.2 MeV.

FIG. 10C. illustrates the refractive index change in the core layer 73 formed by the implantation of He ions accelerated with 2.4 MeV. This ion implantation also forms a fiber Bragg grating at the center of the core.

The above-mentioned method is applicable for an optical waveguide with an upper cladding. For example, in the case of an optical waveguide with a core of 9 μm thickness and an upper cladding of 10 μm thickness, implantation of He ions accelerated with 6 MeV through a mask with slits of 0.1 μm width and slit-forming portions of 0.43 μm width forms a fiber Bragg grating in the core. The projected range of the He ions accelerated with 6 MeV is about 30 μm in silica glass. By using a mask made of gold with 7 μm thickness, the ions irradiated to the masked parts stop in the upper cladding and do not reach the core.

If the upper cladding is much thicker, a fiber Bragg grating is formed by increasing acceleration energy, using ions with smaller lateral straggling, and/or employing a fiber Bragg grating with N>1. The selection of the ion species is the same as mentioned above, i.e., all ion species can be used if the projected range is less than 10 μm, while ions of atoms whose atomic numbers are less than or equal to 36 are good in the case that a projected range of more than 10 μm is required.

If a fiber Bragg grating with thick cladding is desired, the fiber Bragg grating formation process shown in FIGS. 8A-8E is also applicable.

In the above described two ion implantation methods of the present invention, the method that choose an acceleration energy, in which the lateral straggling of implanted ions in an optical waveguide is less than three fourths of the period of a fiber Bragg grating, provides effective refractive index change and forms a fiber Bragg grating with small ion doses. Furthermore, in this method, the implanted ions induce refractive index change in the portion where the ions pass through as shown in FIG. 5A. Hence, this method has the effect of the other invented method that forms the grating shape refractive index change in the portion where the ions pass through.

So far, the above description of this method is the only case where a fiber Bragg grating is formed around the center of the core. It is not necessary that it always be at the center of the core. However, the most effective fiber Bragg grating is obtained by forming the grating around the center of the core. The efficiency of a fiber Bragg grating will be worse when the grating is formed in a different part of the core, and then the number of the grating must be increased.

The above description of this method is also the only case where the acceleration energy is constant during the fabrication of the fiber Bragg grating. The longitudinal thickness of the refractive index change portion can be thickened by implanting ions with varying acceleration energy and a fiber Bragg grating with high efficiency can be obtained.

In the method that forms the grating shape refractive index change in the portion where the ions pass through, the efficiency of the refractive index change is low, and as a result, high ion doses are required. However, this method has an advantage in that the overlap of two adjacent gratings is reduced.

In the above description, the grating is formed in the core and the cladding around the core, while the above-mentioned methods are applicable for forming a Bragg reflection grating only in the cladding, for example, forming a contra-directional coupler (reference material 3: M. Horita et al, Electron. Lett. Vol. 35, pp.1733-1734, 1999.).

So far, the fiber Bragg grating formation methods of the present invention in a silica-based optical waveguide, which includes an optical fiber, have been explained. The methods of the present invention are also applicable for a planar optical waveguide formed with semiconductor materials, e.g., GaAs, InP, or Si, ferroelectric materials, e.g., LiNbO₃ or LiTaO₃, and/or ferromagnetic materials, e.g., Y₃Fe₅O₁₂. These materials show decreases of densities due to ion-implantation induced amorphousation, changes in dielectric constants, and/or chemical reactions with implanted ions. As a result, refractive index change is induced. Therefore, the ion implantation methods described above form a grating in optical waveguides formed with these materials.

[Formation Method of Apodisation]

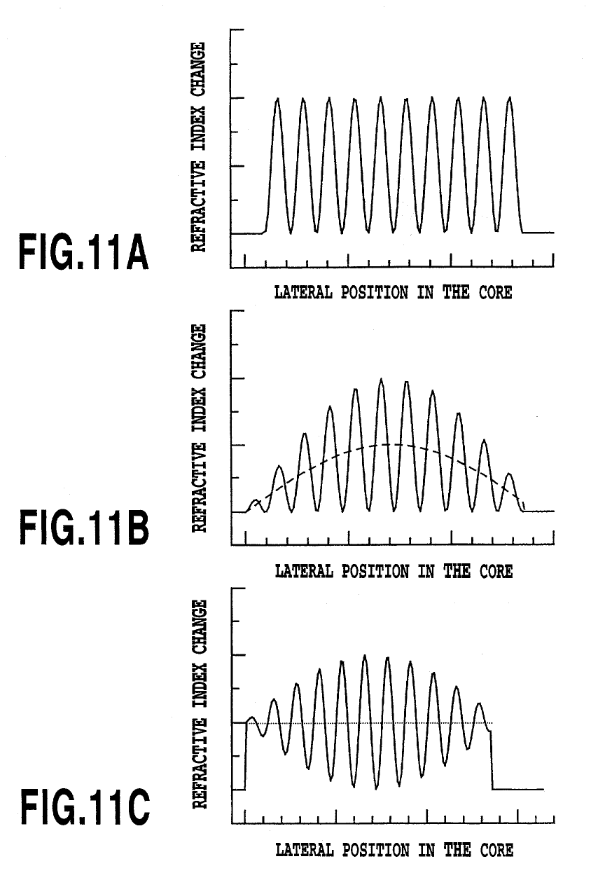

A uniform fiber Bragg grating along the core of an optical waveguide has reflection side modes at the both sides of the wavelength of the Bragg reflection peak, i.e. a filtered wavelength, which deteriorates the property of the fiber Bragg grating. The method called apodisation has been applied to suppress the reflection side modes (reference material 4: B. Malo, et al., Apodised in-fibre Bragg grating reflectors photoimprinted using a phase masks Electron. Lett. Vol. 31, pp.223-225, 1995.). Apodisation is the method that gives a smooth intensity distribution to the refractive index change of the grating along the core. FIG. 11A illustrates the refractive index change of a fiber Bragg grating without apodisation, and FIG. 11B illustrates that of a fiber Bragg grating with apodisation. However, if the intensity distribution shown in FIG. 11B is given to the refractive index changes, the average refractive index in the fiber Bragg grating becomes non-uniform as indicated by the broken curve. The non-uniform average refractive index causes symmetric multi-reflections, and the multi-reflections appear as a Fabry-Perot resonance mode in a wavelength region shorter than the Bragg reflection wavelength. The Fabry-Perot resonance mode is suppressed by flattening the average refractive index of the fiber Bragg grating as shown in FIG. 11C.

The apodisation is realized by controlling the ultraviolet light intensity in the conventional ultraviolet light irradiation method.

In the ion implantation method, the apodisation is realized by implanting ions and distributing them all along the fiber Bragg grating during the fabrication of the fiber Bragg grating. In U.S. Pat. No. 6,115,518, apodisation is formed by controlling the number of the implanted ions by changing the slit width of the mask all along the fiber Bragg grating. However, because of the spread of the implanted ions, the change in the slit width of the mask results in a change in the extent of the overlap of two adjacent gratings, and the efficiency of the fiber Bragg grating is deteriorated.

The present inventor found an apodisation method by ion implantation. In this method, apodisation is given by irradiating an ion beam to an optical waveguide through a mask, where the ion beam is scanned along the core and the scanning speed of the ion beam is varied as it travels along the portion where a fiber Bragg grating is formed. If the diameter or the width of the ion beam is greater than the length of the fiber Bragg grating, it is difficult to form the apodisation by the present method. Therefore, it is desirable that the diameter or the width of the ion beam be less than the length of the fiber Bragg grating.

Furthermore, the present inventor found another apodisation method, which utilizes diffraction of ions by materials. In this method, an ion beam is irradiated to and diffracted by a film and apodisation is formed by making a distribution of the implanted ions from the center to the edges of the fiber Bragg grating by irradiating the diffracted ion beam through a mask.

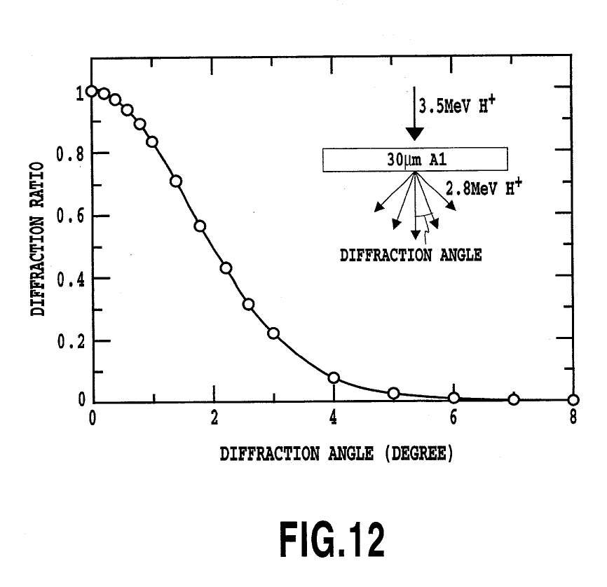

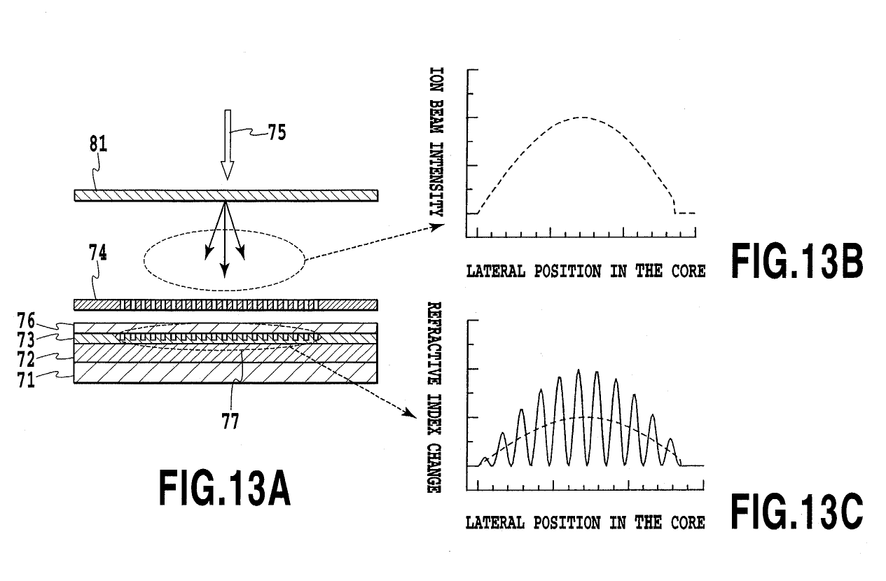

As for the embodiment of the distribution of the ion beam, the distribution of hydrogen ions accelerated with 3.5 MeV diffracted by an aluminum film with a thickness of 30 μm is shown in FIG. 12. The average energy of the diffracted hydrogen ions is 2.8 MeV. The implantation of the distributed hydrogen ions through a mask forms a fiber Bragg grating with apodisation, where the apodisation profile of the refractive index change is almost same as the distribution profile of the ions. However, the distribution profile of the diffracted ions will be almost uniform at the position where the fiber Bragg grating is formed, if the diameter or the width of the ion beam irradiated to the film is greater than the length of the fiber Bragg grating. Therefore, it is desirable that the diameter or the width of the ion beam be less than the length of the fiber Bragg grating. This apodisation method is shown in FIGS. 13A-13C.

FIG. 13A illustrates the formation of refractive index change portions 77 with apodisation by irradiating an accelerated ion beam 75 diffracted by a film 81 to an optical waveguide through a mask 74. Besides aluminum, any materials that can be processed into a film may be used for the film 81. The film 81 can be composed of several materials. A film 81 composed of high-density materials causes a large diffraction angle, while a film 81 composed of low-density materials causes a small diffraction angle. When identical materials are used for films 81, a thick film 81 causes a large diffraction angle, while a thin film 81 causes a small diffraction angle. If the distance from the film 81 to the mask 74 is short, the diffraction width will be narrow, while if the distance from the film 81 to the mask 74 is large, the diffraction width will be wide. Therefore, a desired apodisation profile is obtained by choosing appropriate materials and appropriate thickness for the film 81 and appropriate distance from the film 81 to the mask 74. In other words, the desired apodisation profile defines the material and the thickness of the film 81 and the distance from the film 81 to the mask 74. However, ions are not able to pass through films 81, which are too thick. Even if aluminum, which has low ion stopping power, is employed in the film, hydrogen ions, which have the greatest penetration depth, require an acceleration energy of more than 10 MeV to pass through the film with a thickness of more than 600 μm. Therefore, the film thickness must be chosen by considering the penetration depth of the implanted ions.

The above-described apodisation methods are applicable for all fiber Bragg grating formation processes by ion implantation.

The present inventor found a method to make an apodised fiber Bragg grating with a flat average refractive index as shown in FIG. 11C by using ion implantation. This method forms an apodised fiber Bragg grating with flat average refractive index by irradiating an ion beam that is scanned along the core to an apodised fiber Bragg grating shown in FIG. 11B and varying the scanning speed of the ion beam as it travels along the fiber Bragg grating. If the diameter or the width of the ion beam is greater than the length of the apodised fiber Bragg grating, it is difficult to make the flat average refractive index in the apodised fiber Bragg grating by the present method. Therefore, it is desirable that the diameter or the width of the ion beam be less than the length of the fiber Bragg grating.

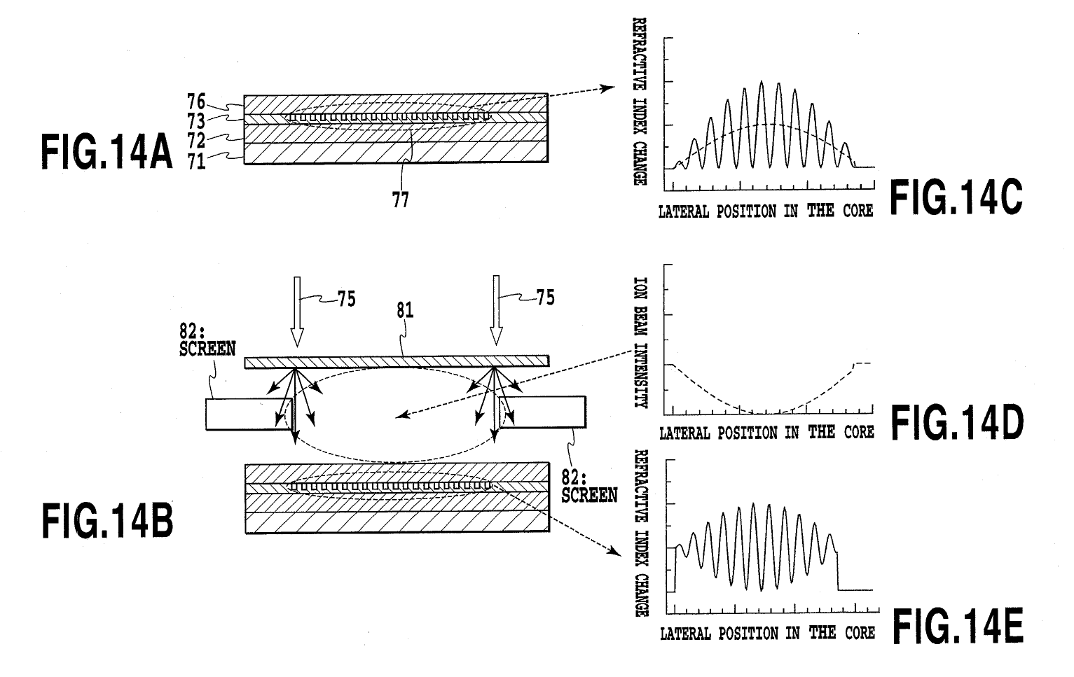

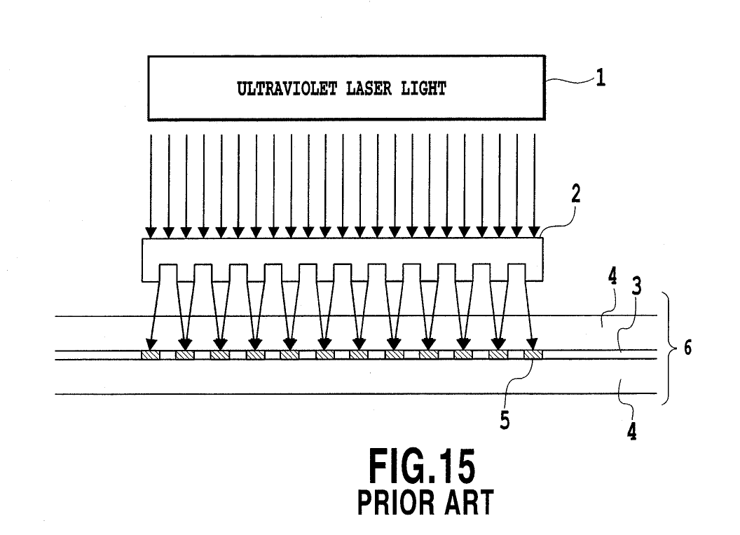

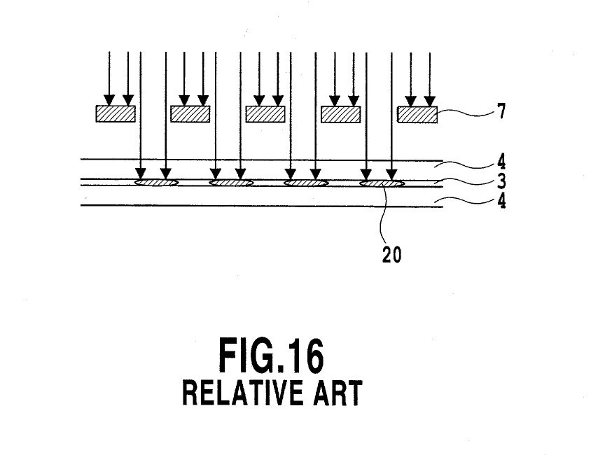

Furthermore, the present inventor found another method to make an apodised fiber Bragg grating with a flat average refractive index as shown in FIG. 11C or 14E. As shown in FIG. 14B, ion beams 75 are irradiated to and diffracted by a film 81. An ion beam whose distribution profile is the inverse of the profile of the average refractive index of the apodised fiber Bragg grating shown in FIG. 11B or 14C is formed by the diffracted ion beams as shown in FIG. 14D, and the irradiation of the ion beam to the apodised fiber Bragg grating as shown in FIG. 11B or 14C makes the average refractive index of the fiber Bragg grating flat.

Ions are diffracted when the ions pass through a film as shown in FIG. 12. Ion beams 75 and 75 are irradiated to two parts of the film 81 and the edges of the two diffracted ion beams are irradiated to the apodised fiber Bragg grating formed with refractive index change portions 77 as shown in FIG. 14B. Due to the irradiation, the average refractive index of the apodised fiber Bragg grating becomes flat.

These methods to make an apodised fiber Bragg grating with a flat average refractive index are applicable to all fiber Bragg gratings with apodisation as shown in FIG. 11B. In other words, the average refractive index of an apodised fiber Bragg grating shown in FIG. 11B formed by ion implantation or ultraviolet light irradiation is flattened by the method that irradiates an ion beam that is scanned along the core with varying the scanning speed as it travels along the fiber Bragg grating, or by the method which irradiates diffracted ion beams as shown in FIGS. 14A-14E.

[Modified Embodiment of the Present Invention]

The above-mentioned ion implantation conditions concerned with the present invention are applied not only for the fiber Bragg grating but also for the long period grating, and the above-mentioned embodiments of the present invention are also applied for the long period grating.

The present invention has been described in detail with respect to preferred embodiments, and it will now be apparent from the foregoing to those skilled in the art that changes and modifications may be made without departing from the invention in its broader aspect, and it is the intention, therefore, in the appended claims to cover all such changes and modifications as fall within the true spirit of the invention.

What is claimed is:

1. An optical waveguide grating formed in an optical waveguide core and/or in an optical waveguide cladding where an electric field of light propagating in said core is spreading, comprising:
a periodic refractive index change portion formed in said core and/or in said cladding by implanting accelerated ions into said core and/or into said cladding through a mask,
wherein the thickness of said mask is thick enough to prevent the ions irradiated to the masked parts from reaching said core, or the height of projections against grooves that correspond to slits of said mask is high enough to prevent the ions irradiated to said projections from reaching said core.

2. The optical waveguide grating as claimed in claim 1, wherein the thickness of said mask is thinner than the projected range of said implanted ions, or the height of said projections against said grooves that correspond to said slits of said mask is lower than the projected range of said implanted ions.

3. An optical waveguide grating formed in an optical waveguide core and/or in an optical waveguide cladding where an electric field of light propagating in said core is spreading, comprising:
a periodic refractive index change portion formed in said core and/or in said cladding by implanting accelerated ions into said core and/or into said cladding through a mask,
wherein the thickness of said mask is thick enough to prevent the ions irradiated to the masked parts from reaching a portion where said optical waveguide grating is formed, or the height of projections against grooves that correspond to slits of said mask is high enough to prevent the ions irradiated to said projections from reaching a portion where said optical waveguide grating is formed.

4. The optical waveguide grating as claimed in claim 3, wherein the thickness of said mask is thinner than the projected range of said implanted ions, or the height of said projections against said grooves that correspond to said slits of said mask is lower than the projected range of said implanted ions.

5. A method for forming an optical waveguide grating comprising:
implanting accelerated ions into an optical waveguide core and/or into an optical waveguide cladding where an electric field of light propagating in said core is spreading through a mask; and
forming a periodic refractive index change portion in said core and/or in said cladding by said ion implantation,
wherein the thickness of said mask is thick enough to prevent the ions irradiated to the masked parts from reaching said core, or the height of projections against grooves that correspond to slits of said mask is high enough to prevent the ions irradiated to said projections from reaching said core.

6. The method as claimed in claim 5, wherein the thickness of said mask is thinner than the projected range of said implanted ions, or the height of said projections against said grooves that correspond to said slits of said mask is lower than the projected range of said implanted ions.

7. A method for forming an optical waveguide grating comprising:
implanting accelerated ions into an optical waveguide core and/or into an optical waveguide cladding where an electric field of light propagating in said core is spreading through a mask; and
forming a periodic refractive index change portion in said core and/or in said cladding by said ion implantation,
wherein the thickness of said mask is thick enough to prevent the ions irradiated to the masked parts from reaching a portion where said optical waveguide grating is formed, or the height of projections against grooves that correspond to slits of said mask is high enough to prevent the ions irradiated to said projections from reaching a portion where said optical waveguide grating is formed.

8. The method as claimed in claim 7, wherein the thickness of said mask is thinner than the projected range of said implanted ions, or the height of said projections against said grooves that correspond to said slits of said mask is lower than the projected range of said implanted ions.

9. A mask for forming an optical waveguide grating by forming a periodic refractive index change portion in an optical waveguide core and/or in an optical waveguide cladding where an electric field of light propagating in said core is spreading by implanting accelerated ions into said core and/or into said cladding through said mask, wherein said mask has a grating shape composed with a plurality of slits with a width of 50 nm to 5 μm and slit-forming portions with a width of 50 nm to 5 μm.

10. The mask as clamed in claim 9, wherein said mask has, on a flat plate, a plurality of grooves corresponding to said slits and projections corresponding to said slit-forming portions, the grooves and the projections being periodically formed.

11. The mask as clamed in claim 9, wherein said mask has a plurality of holes which are periodically formed in a manner corresponding to said slits on a flat plate.

12. The mask as clamed in claim 9, wherein said mask is formed by coating or deposition of metals, semiconductor materials, ceramic materials, or polymer materials with a grating shape that corresponds to said slits and said slit-forming portions on the cladding surface of said optical waveguide.

13. The mask as clamed in claim 9, wherein said mask is formed by coating or deposition of metals, semiconductor materials, ceramic materials, or polymer materials with a grating shape that corresponds to said slits and said slit-forming portions on the surface of the core layer of said optical waveguide before forming an upper cladding.

14. The mask as clamed in claim 9, wherein said mask is formed by giving periodic grooves corresponding to said slits and projections corresponding to said slit-forming portions to said cladding of said optical waveguide by etching or scraping.

15. The mask as clamed in claim 9, wherein said slits of said mask are filled with materials that have smaller ion stopping power than the material of said mask.

16. The mask as clamed in claim 9, wherein the sum of said widths of said slit and said slit-forming portion satisfies the Bragg reflection condition of the light to be filtered in said optical waveguide.

17. An optical waveguide grating formed in an optical waveguide core and/or in an optical waveguide cladding where an electric field of light propagating in said core is spreading, comprising:
a periodic refractive index change portion formed in said core and/or in said cladding by implanting accelerated ions into said core and/or into said cladding through a mask,
wherein the acceleration energy is chosen to make the lateral straggling of said implanted ions in said optical waveguide less than three fourths of said period of said refractive index change portion.

18. The optical waveguide grating as claimed in claim 17, wherein said periodic refractive index change is formed in said core and/or in said cladding by implanting said ions with varying acceleration energy.

19. The optical waveguide grating as claimed in claim 17, wherein apodisation is given to the value of said periodic refractive index change by irradiating the beam of said ions that is scanned along said core of said optical waveguide and varying the scanning speed of said beam of said ions.

20. The optical waveguide grating as claimed in claim 17, wherein apodisation is given to the value of said periodic refractive index change by irradiating the beam of said ions that is scanned along said core of said optical waveguide and varying the scanning speed of said beam of said ions.

21. An optical waveguide grating formed in an optical waveguide core and/or in an optical waveguide cladding where an electric field of light propagating in said core is spreading, comprising:
a periodic refractive index change portion formed in said core and/or in said cladding by implanting accelerated ions into said core and/or into said cladding through a mask,
wherein the acceleration energy is chosen to make all or a part of said implanted ions pass through the portion where said periodic refractive index change is formed.

22. The optical waveguide grating as claimed in claim 21, wherein said periodic refractive index change is formed in said core and/or in said cladding by implanting said ions with varying acceleration energy.

23. The optical waveguide grating as claimed in claim 21, wherein apodisation is given to the value of said periodic refractive index change by irradiating the beam of said ions that is scanned along said core of said optical waveguide and varying the scanning speed of said beam of said ions.

24. The optical waveguide grating as claimed in claim 21, wherein the beam of said ions is irradiated to and diffracted by a film, and apodisation is given to the value of said periodic refractive index change by making a distribution of said implanted ions from the center to the edges of said optical waveguide grating by irradiating said diffracted ion beam to said optical waveguide through said mask.

25. An optical waveguide grating formed in an optical waveguide core and/or in an optical waveguide cladding where an electric field of light propagating in said core is spreading, comprising:
a periodic refractive index change portion with apodisation along said core of said optical waveguide formed by ion implantation or ultraviolet light irradiation,
wherein the average refractive index of said apodised optical waveguide grating is flattened by irradiating an ion beam that is scanned along said core of said optical waveguide and varying the scanning speed of said ion beam.

26. An optical waveguide grating formed in an optical waveguide core and/or in an optical waveguide cladding where an electric field of light propagating in said core is spreading, comprising:
a periodic refractive index change portion with apodisation along said core of said optical waveguide formed by ion implantation or ultraviolet light irradiation,
wherein an ion beam, which has a distribution profile that is the inverse of the average refractive index profile of said apodised optical waveguide grating, is formed by ion beams that have been irradiated to and diffracted by a film, and said average refractive index of said apodised optical waveguide grating is flattened by irradiating said ion beam.

27. A method for forming an optical waveguide grating comprising:
implanting accelerated ions into an optical waveguide core and/or into an optical waveguide cladding where an electric field of light propagating in said core is spreading through a mask; and
forming a periodic refractive index change portion in said core and/or in said cladding by said ion implantation,
wherein the acceleration energy is chosen to make the lateral straggling of said implanted ions in said optical waveguide less than three fourths of said period of said refractive index change portion.

28. The method as claimed in claim 27 using the ion implantation method in which said periodic refractive index change is formed in said core and/or in said cladding by implanting said ions with varying acceleration energy.

29. The method as claimed in claims 27 using the ion implantation method in which apodisation is given to the value of said periodic refractive index change by irradiating the beam of said ions that is scanned along said core of said optical waveguide and varying the scanning speed of said beam of said ions.

30. The method as claimed in claim 27 using the ion implantation method in which the beam of said ions is irradiated to and diffracted by a film, and apodisation is given to the value of said periodic refractive index change by making a distribution of said implanted ions from the center to the edges of said optical waveguide grating by irradiating said diffracted ion beam to said optical waveguide through said mask.

31. The method as claimed in claim 27 forming an optical waveguide grating greater than the diameter of the beam of said ions by irradiating said beam of said ions that is scanned along said core of said optical waveguide.

32. A method for forming an optical waveguide grating comprising:
implanting accelerated ions into an optical waveguide core and/or into an optical waveguide cladding where an electric field of light propagating in said core is spreading through a mask; and
forming a periodic refractive index change portion in said core and/or in said cladding by said ion implantation,
wherein the acceleration energy is chosen to make all or a part of said implanted ions pass through the portion where said periodic refractive index change is formed.

33. The method as claimed in claim 32 using the ion implantation method in which said periodic refractive index change is formed in said core and/or in said cladding by implanting said ions with varying acceleration energy.

34. The method as claimed in claim 32 using the ion implantation method in which apodisation is given to the value of said periodic refractive index change by irradiating the beam of said ions that is scanned along said core of said optical waveguide and varying the scanning speed of said beam of said ions.

35. The method as claimed in claims 32 using the ion implantation method in which the beam of said ions is irradiated to and diffracted by a film, and apodisation is given to the value of said periodic refractive index change by making a distribution of said implanted ions from the center to the edges of said optical waveguide grating by irradiating said diffracted ion beam to said optical waveguide through said mask.

36. The method as claimed in claims 32 forming an optical waveguide grating greater than the diameter of the beam of said ions by irradiating said beam of said ions that is scanned along said core of said optical waveguide.

37. A method for forming an optical waveguide grating in an optical waveguide core and/or in an optical waveguide cladding where an electric field of light propagating in said core is spreading, comprising:
forming a periodic refractive index change portion with apodisation along said core of said optical waveguide by ion implantation or ultraviolet light irradiation; and
flattening the average refractive index of said apodised optical waveguide grating by irradiating an ion beam that is scanned along said core of said optical waveguide and varying the scanning speed of said ion beam.

38. A method for forming an optical waveguide grating in an optical waveguide core and/or in an optical waveguide cladding where an electric field of light propagating in said core is spreading, comprising:
forming a periodic refractive index change portion with apodisation along said core of said optical waveguide by ion implantation or ultraviolet light irradiation;
forming an ion beam, which has a distribution profile that is the inverse of the average refractive index profile of said apodised optical waveguide grating, by ion beams that have been irradiated to and diffracted by a film; and
flattening said average refractive index of said apodised optical waveguide grating by irradiating said ion beam.
